(19) United States
(12) Patent Application Publication
(10) Pub. No.: US 2026/0011496 A1
(43) Pub. Date: Jan. 8, 2026

(54) METHOD FOR MANUFACTURING MULTILAYER CERAMIC SUBSTRATE HAVING COOLING SYSTEM AND MULTILAYER CERAMIC SUBSTRATE HAVING COOLING MEANS MANUFACTURED THEREOF

(71) Applicant: DIT CO.,LTD., Osan-si (KR)

(72) Inventor: Tae Hyung NOH, Siheung-si (KR)

(73) Assignee: DIT CO.,LTD., Osan-si (KR)

(21) Appl. No.: 19/257,487

(22) Filed: Jul. 2, 2025

(30) Foreign Application Priority Data
Jul. 2, 2024 (KR) 10-2024-0086542

(51) Int. Cl. H01G 4/008; H01G 4/012; H01G 4/30

(52) U.S. Cl. CPC H01G 4/0085; H01G 4/012; H01G 4/30

(57) ABSTRACT

The present invention relates to a method for manufacturing a multilayer ceramic substrate having a cooling system, which includes a preparation operation of preparing a plurality of ceramic sheets formed by sintering ceramic green sheets, wherein the plurality of ceramic sheets include a first ceramic sheet and a second ceramic sheet; a via hole forming operation of forming a via hole in the ceramic sheets; a via electrode forming operation of forming a via electrode in the via hole; a pattern electrode forming operation of forming a pattern electrode on one surface of the ceramic sheets; a bonding layer forming operation of forming a bonding layer by coating one surface of the ceramic sheets with a bonding agent; a cover part processing operation of bonding and laminating a plurality of first ceramic sheets to each other, processing the first ceramic sheets, and forming an inlet into which a fluid is introduced and an outlet through which the fluid is discharged; an accommodation part processing operation of bonding and laminating a plurality of second ceramic sheets to each other, processing the second ceramic sheets, and forming a fluid accommodation space; and a bonding operation of bonding the laminated first ceramic sheets and the laminated second ceramic sheets to each other.

According to the present invention, since an interposer provided with a processing chip and/or a memory chip is installed in a fluid accommodation space formed inside the multilayer ceramic substrate, the corresponding chip can be effectively cooled, and heat generated from the corresponding chip can be prevented from being transferred to the multilayer ceramic substrate.

### CROSS-REFERENCE TO RELATED APPLICATION

This application claims priority to and the benefit of Korean Patent Application No. 2024-0086542, filed on Jul. 2, 2024, the disclosure of which is incorporated herein by reference in its entirety.

### BACKGROUND

### Field of the Invention

The present invention relates to a method for manufacturing a multilayer ceramic substrate having a cooling system and a multilayer ceramic substrate having a cooling system manufactured thereof.

### Discussion of Related Art

Multilayer ceramic substrates are widely used as replacements for existing printed circuit boards (PCBs) due to their heat resistance, wear resistance, excellent insulation, and mechanical strength characteristics, and their demand is gradually increasing. Multilayer ceramic substrates are used as composite components that combine active components such as semiconductor integrated circuit (IC) chips and passive components, such as capacitors, inductors, and resistors, or used as simple semiconductor IC packages. More specifically, multilayer ceramic substrates are widely used to constitute various electronic components such as power amplifier (PA) module substrates, radio frequency (RF) diode switches, filters, chip antennas, various package components, and composite devices.

A multilayer ceramic substrate includes a plurality of stacked ceramic layers, and various types of line conductors are formed in the multilayer ceramic substrate. Examples of the line conductors include a pattern electrode formed in a certain pattern and extending along a specific interface between ceramic layers, a via electrode formed to extend and pass through a specific ceramic layer, and an external electrode E formed to extend onto an outer surface of the multilayer ceramic substrate. In order to increase the functionality, density and performance of the multilayer ceramic substrate, it is essential to arrange the above-described line conductors at a high density.

The multilayer ceramic substrates are generally manufactured by a method referred to as a green sheet lamination method. This method involves forming a via hole in a green sheet obtained by forming slurry of a ceramic powder and an organic binder, screen-printing a conductive paste, overlapping a required number of the green sheets, heating and pressing the green sheets, and then laminating and sintering the green sheets. The green sheet lamination method has an advantages of providing rich flexibility to the green sheets and making it easy for the green sheets to absorb organic solvents and providing excellent surface smoothness and airtightness required for multilayering several dozen layers.

On the other hand, as a disadvantage, in order to obtain a multilayer ceramic substrate, green sheets on which line conductors are formed should be laminated and a sintering process should be performed to obtain excellent characteristics. However, when the sintering process is performed, contraction due to the sintering of the ceramic occurs. This contraction is unlikely to occur uniformly across the entire multilayer ceramic substrate, resulting in dimensional deformation toward a surface of a ceramic layer. In addition, the contraction in the plane direction causes undesired deformation or distortion in the line conductor, and more specifically, the positional accuracy of external electrodes for connection of chip components mounted on the multilayer ceramic substrate may be reduced or an open circuit may occur in the line conductor. In this way, when the contraction in the plane direction occurs, misalignment occurs between the conductive pattern and the components when the components are mounted, and thus it is impossible to mount semiconductor chips such as a chip size package (CSP) and multi-chip modules (MCMs) with high precision. In addition, stress concentration occurs at a contact point between the ceramic surface and the electrode due to different sintering behaviors of different materials, and thus many defects, such as cracks and delamination, occur.

Meanwhile, as technology has advanced in recent years, the integration of electronic components has become increasingly higher. In particular, although performance of processing chips such as central processing units (CPUs)/graphics processing units (GPUs)/neural network processing units (NPUs) and high bandwidth memory (HBM) chips is increasing so that they can calculate or process large amounts of data at high speeds per unit time, a problem of heat generation due to the high integration and high performance of the electronic components is becoming a major issue.

In addition, a multilayer ceramic substrate on which electronic components are mounted also has a constant thermal conductivity according to the composition material, and therefore as the integration of the internal circuit increases, the amount of heat generated increases. This heat generation deteriorates the various electronic components mounted on the multilayer ceramic substrate, causing the electronic components to malfunction, such as by shortening their lifetime and reducing their efficiency. Accordingly, a separate device for heat dissipation is required within the multilayer ceramic substrate.

### RELATED ART DOCUMENT

### Patent Document

(Patent Document 0001) Korean Patent Registration No. 10-0673860 (Jan. 25, 2007)

### SUMMARY OF THE INVENTION

The present invention is directed to a method for manufacturing a multilayer ceramic substrate in which a microfluid channel or a cooling system of a fluid accommodation space is provided, and a multilayer ceramic substrate having a cooling system manufactured thereof.

According to an aspect of the present invention, there is provided a method of manufacturing a multilayer ceramic substrate formed by sintering a plurality of ceramic green sheets to form a plurality of ceramic sheets and then laminating the plurality of ceramic sheets, which includes a preparation operation of preparing the plurality of ceramic sheets, wherein the plurality of ceramic sheets include a first ceramic sheet and a second ceramic sheet; a via hole forming operation of forming a via hole in the ceramic sheets; a via electrode forming operation of forming a via electrode in the via hole; a pattern electrode forming operation of forming a pattern electrode on one surface of the ceramic sheets; a bonding layer forming operation of forming a bonding layer by coating one surface of the ceramic sheets with a bonding agent; a channel forming operation of forming a microfluidic channel by processing the second ceramic sheet; and a bonding operation of bonding the plurality of ceramic sheets to each other through the bonding layer.

In addition, the microfluidic channel may be formed to avoid the via electrode.

In addition, the microfluidic channel may include straight portions and a curved portion connecting the straight portions.

In addition, an inlet and an outlet of the microfluidic channel may be formed in different layers.

In addition, at least one of an inlet and an outlet of the microfluidic channel may be formed in a width direction of the second ceramic sheet.

In addition, at least one of an inlet and an outlet of the microfluidic channel may be formed in a thickness direction of the second ceramic sheet.

In addition, the microfluidic channel may be formed as a plurality of microfluidic channels.

In addition, a height of the microfluidic channel may range from 30 μm to 300 μm, and a width of the microfluidic channel may range from 30 μm to 1000 μm.

According to another aspect of the present invention, there is provided a multilayer ceramic substrate formed by sintering a plurality of ceramic green sheets to form a plurality of ceramic sheets and then laminating the plurality of ceramic sheets, which includes the plurality of ceramic sheets in which via electrodes are formed; a pattern electrode formed on one surface of the ceramic sheets; and a bonding layer configured to bond the plurality of ceramic sheets to each other, wherein the ceramic sheets include a first ceramic sheet and a second ceramic sheet, and a microfluidic channel is formed in the second ceramic sheet.

According to still another aspect of the present invention, a method of manufacturing a multilayer ceramic substrate having a cooling system includes a preparation operation of preparing a plurality of ceramic sheets formed by sintering ceramic green sheets, wherein the plurality of ceramic sheets include a first ceramic sheet and a second ceramic sheet; a via hole forming operation of forming a via hole in the ceramic sheets; a via electrode forming operation of forming a via electrode in the via hole; a pattern electrode forming operation of forming a pattern electrode on one surface of the ceramic sheets; a bonding layer forming operation of forming a bonding layer by coating one surface of the ceramic sheets with a bonding agent; a cover part processing operation of bonding and laminating a plurality of first ceramic sheets to each other, processing the first ceramic sheets, and forming an inlet into which a fluid is introduced and an outlet through which the fluid is discharged; an accommodation part processing operation of bonding and laminating a plurality of second ceramic sheets to each other, processing the second ceramic sheets, and forming a fluid accommodation space; and a bonding operation of bonding the laminated first ceramic sheets and the laminated second ceramic sheets to each other.

In addition, an interposer may be installed in the fluid accommodation space, and the interposer may be provided with a processing chip.

In addition, the interposer may be provided with a memory chip.

According to yet another aspect of the present invention, there is provided a multilayer ceramic substrate formed by sintering a plurality of ceramic green sheets to form a plurality of ceramic sheets and then laminating the plurality of ceramic sheets, which includes the plurality of ceramic sheets in which via electrodes are formed, a pattern electrode formed on one surface of the ceramic sheets, and a bonding layer configured to bond the plurality of ceramic sheets to each other, wherein the ceramic sheets include a first ceramic sheet and a second ceramic sheet, an inlet into which a fluid is introduced and an outlet through which the fluid is discharged are formed in the laminated first ceramic sheet, and a fluid accommodation space is formed in the laminated second ceramic sheet.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart illustrating a method of manufacturing a multilayer ceramic substrate having a cooling system according to a first embodiment of the present invention;

FIGS. 2 and 3 are diagrams illustrating a process of manufacturing a multilayer ceramic substrate having a cooling system according to a method of manufacturing a multilayer ceramic substrate having a cooling system according to the first embodiment of the present invention;

FIG. 4 is a diagram illustrating a process of processing a second ceramic sheet in the method of manufacturing a multilayer ceramic substrate having a cooling system according to the first embodiment of the present invention;

FIG. 5 is a diagram illustrating that an inlet and an outlet of a microfluidic channel are formed in a width direction of the second ceramic sheet in the method of manufacturing a multilayer ceramic substrate having a cooling system according to the first embodiment of the present invention;

FIG. 6 is a diagram illustrating that an inlet and outlet of the microfluidic channel are formed in a thickness direction and a width direction of the second ceramic sheet in the method of manufacturing a multilayer ceramic substrate having a cooling system according to the first embodiment of the present invention;

FIG. 7 is a diagram illustrating a case in which a microfluidic channel has a single-layer structure in the multilayer ceramic substrate having a cooling system according to the first embodiment of the present invention;

FIG. 8 is a diagram illustrating a case in which a microfluidic channel has a multilayer structure in the multilayer ceramic substrate having a cooling system according to the first embodiment of the present invention;

FIG. 9 is a flowchart illustrating a method of manufacturing a multilayer ceramic substrate having a cooling system according to a second embodiment of the present invention;

FIG. 10 is a diagram illustrating a cover part and an accommodation part formed through the method of manufacturing a multilayer ceramic substrate having a cooling system according to the second embodiment of the present invention;

FIG. 11 is a diagram illustrating the cover part and the accommodation part that are bonded in the method of manufacturing a multilayer ceramic substrate having a cooling system according to the second embodiment of the present invention;

FIG. 12 is a diagram illustrating circulation of a fluid in a fluid accommodation space formed through the method of manufacturing a multilayer ceramic substrate having a cooling system according to the second embodiment of the present invention; and

FIG. 13 is a plan view illustrating a multilayer ceramic substrate manufactured through the method of manufacturing a multilayer ceramic substrate having a cooling system according to the second embodiment of the present invention.

### DETAILED DESCRIPTION OF EXEMPLARY EMBODIMENTS

Hereinafter, some embodiments of the present invention will be described in detail with reference to the illustrative drawings. In giving reference numerals to components of the drawings, the same reference numerals are given to the same components even when the same components are shown in different drawings.

In addition, in describing embodiments of the present invention, when a detailed description of related known configurations or functions is determined to hinder understanding of the embodiment of the present invention, the detailed description thereof will be omitted.

Further, in describing components of the embodiment of the present disclosure, terms such as “first,” “second,” “A,” “B,” “(a),” “(b),” etc., can be used. These terms are intended to distinguish one component from other components, but the nature and the order or sequence of the components is not limited by those terms.

Hereinafter, with reference to the accompanying drawings, a method S100 of manufacturing a multilayer ceramic substrate having a cooling system according to a first embodiment of the present invention will be described in detail.

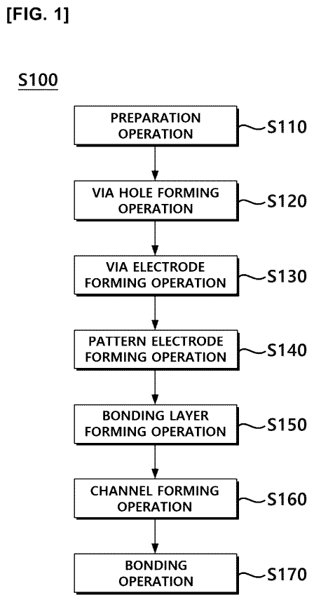

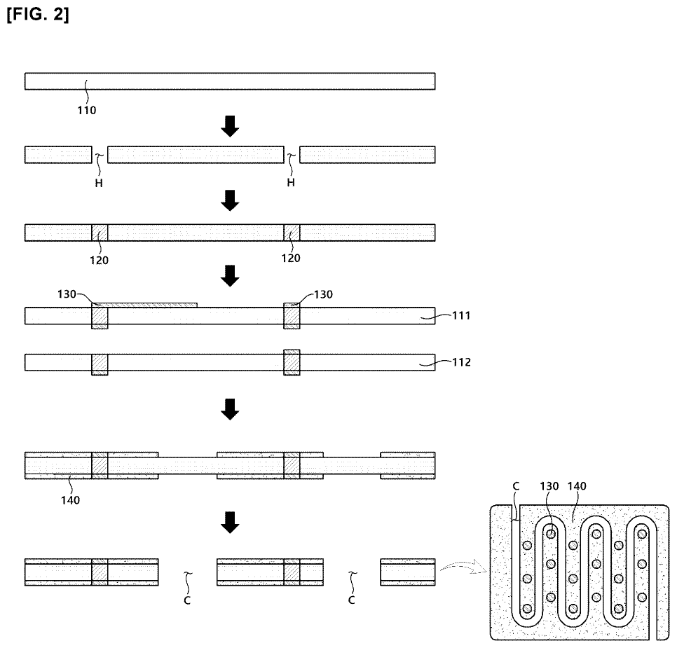

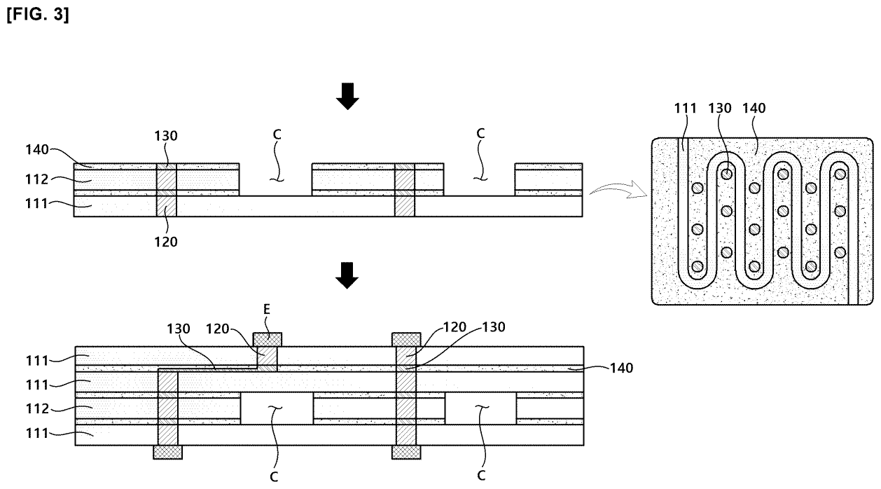

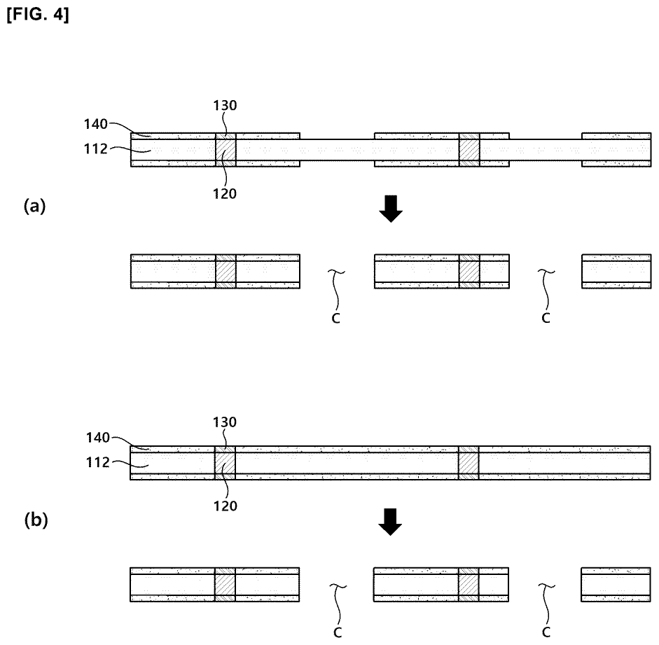

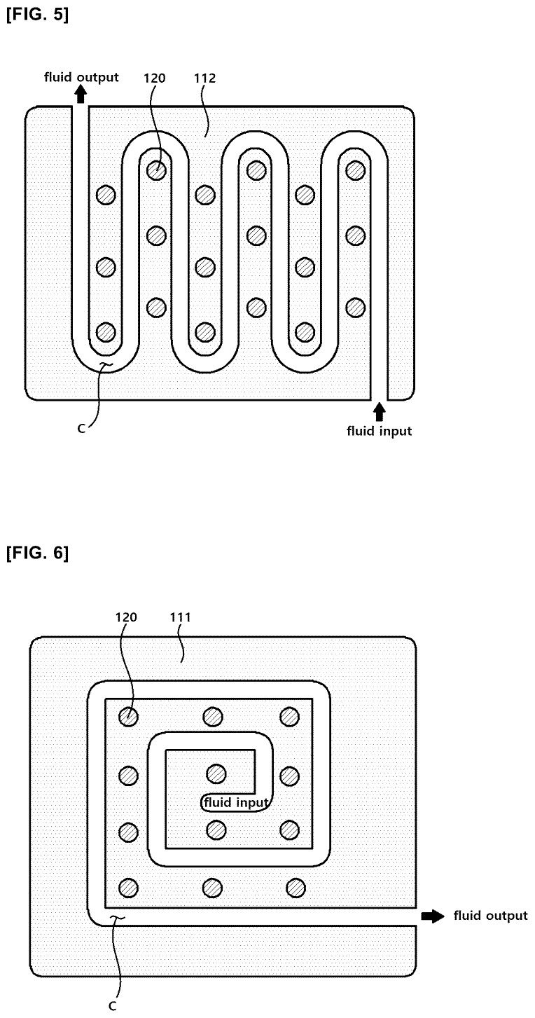

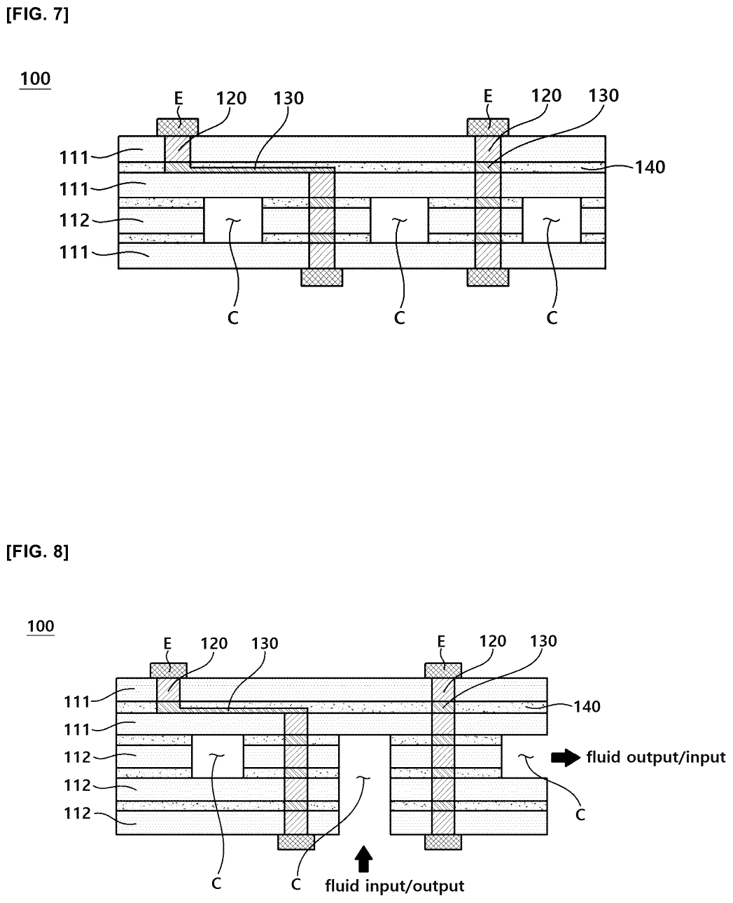

FIG. 1 is a flowchart illustrating a method of manufacturing a multilayer ceramic substrate having a cooling system according to a first embodiment of the present invention, FIGS. 2 and 3 are diagrams illustrating a process of manufacturing a multilayer ceramic substrate having a cooling system according to a method of manufacturing a multilayer ceramic substrate having a cooling system according to the first embodiment of the present invention, FIG. 4 is a diagram illustrating a process of processing a second ceramic sheet in the method of manufacturing a multilayer ceramic substrate having a cooling system according to the first embodiment of the present invention, FIG. 5 is a diagram illustrating that an inlet and an outlet of a microfluidic channel are formed in a width direction of the second ceramic sheet in the method of manufacturing a multilayer ceramic substrate having a cooling system according to the first embodiment of the present invention, FIG. 6 is a diagram illustrating that an inlet and outlet of the microfluidic channel are formed in a thickness direction and a width direction of the second ceramic sheet in the method of manufacturing a multilayer ceramic substrate having a cooling system according to the first embodiment of the present invention, FIG. 7 is a diagram illustrating a case in which a microfluidic channel has a single-layer structure in the multilayer ceramic substrate having a cooling system according to the first embodiment of the present invention, and FIG. 8 is a diagram illustrating a case in which a microfluidic channel has a multilayer structure in the multilayer ceramic substrate having a cooling system according to the first embodiment of the present invention.

As shown in FIGS. 1 to 3, the method S100 of manufacturing a multilayer ceramic substrate having a cooling system according to a first embodiment of the present invention includes a preparation operation S110, a via hole forming operation S120, a via electrode forming operation S130, a pattern electrode forming operation S140, a bonding layer forming operation S150, a channel forming operation S160, and a bonding operation S170.

The preparation operation S110 is an operation of preparing a plurality of ceramic sheets 110 formed by sintering a plurality of ceramic green sheets.

A multilayer ceramic substrate 100 having a cooling system according to the present invention is characterized in that, rather than conventionally manufacturing the multilayer ceramic substrate 100 by laminating and then sintering the plurality of ceramic green sheets, the multilayer ceramic substrate 100 is manufactured by sintering the plurality of ceramic green sheets individually to manufacture the plurality of ceramic sheets 110, and then laminating and bonding the manufactured ceramic sheets 110 in that order.

A temperature for sintering the ceramic green sheets to manufacture the ceramic sheets 110 in the preparation operation S110 may range from 1000° C. to 1700° C., and the ceramic green sheet may be sintered for 1 hour to 5 hours in an oxygen-free reduction environment or an air environment. In addition, a diameter of the ceramic green sheets and/or the ceramic sheets 110 may be 12 inches or greater, and the ceramic sheets 110 manufactured by sintering the ceramic green sheets may have a thickness of 30 μm to 300 μm.

Meanwhile, the plurality of ceramic sheets 110 include a first ceramic sheet 111 on which a via electrode 120 is formed, and a second ceramic sheet 112 on which the via electrode 120 and a microfluidic channel C are formed, and the first and second ceramic sheets 111 and 112 will be described below.

The via hole forming operation S120 is an operation of forming one or more via holes H in each of the plurality of ceramic sheets 110, i.e., the first ceramic sheet 111 and/or the second ceramic sheet 112.

In this case, the via hole H may be formed through a process such as laser irradiation or chemical etching, and the via hole H may have a diameter of 10 μm to 300 μm. Meanwhile, the via holes H formed in the same ceramic sheet 110 may have the same diameter or different diameters.

The via electrode forming operation S130 is an operation of forming the via electrode 120 in the via hole H.

More specifically, the via electrode forming operation S130 is an operation of filling the via hole H, which is formed in each of the plurality of ceramic sheets 110, with a conductive paste and sintering the ceramic sheets 110 to form the via electrode 120. The via electrode 120 serves as an electrode that electrically connects layers when the plurality of ceramic sheets 110 are laminated to manufacture the multilayer ceramic substrate 100. In addition, the conductive paste filling the via hole H may include one or more materials among Ag, Cu, Au, Pd, Pt, Ag—Pd, Ni, Mo, and W, but the present invention is not limited thereto.

The pattern electrode forming operation S140 is an operation of forming pattern electrodes 130 to electrically connect a plurality of via electrodes 120 to one surface of the plurality of ceramic sheets 110, i.e., the first ceramic sheet 111 and/or the second ceramic sheet 112.

More specifically, the pattern electrode forming operation S140 may include forming the pattern electrodes 130 by printing a pattern using a conductive paste on one surface of one of the ceramic sheets 110 other than the ceramic sheet 110 located at the uppermost or lowermost layer of the multilayer ceramic substrate 100 according to the present invention and sintering the pattern. The pattern electrodes 130 are then present inside the multilayer ceramic substrate 100 and may electrically connect the plurality of via electrodes 120 to each other.

In addition, the conductive paste for forming the pattern electrode 130 may include one or more materials among Ag, Cu, Au, Pd, Pt, Ag—Pd, Ni, Mo, and W, but the present invention is not limited thereto.

Meanwhile, since the pattern electrode 130 is formed after the via electrode 120 is formed, the pattern electrode 130 is formed at a temperature lower than the sintering temperature of the via electrode 120.

The bonding layer forming operation S150 is an operation of forming a bonding layer 140 by coating one surface of the plurality of ceramic sheets 110, i.e., the first ceramic sheet 111 and/or the second ceramic sheet 112, with a bonding agent.

More specifically, in the bonding layer forming operation S150, the bonding layer 140 is formed by coating one surface of the ceramic sheet 110, on which the above-described process is performed, with the bonding agent to bond the plurality of ceramic sheets 110 to each other. In this case, portions other than portions where the via electrode 120 and the pattern electrode 130 are formed may be coated with the bonding agent.

The bonding agent may be prepared as a material that does not affect the printed pattern electrode 130, the bonding agent may be an inorganic and/or organic material, when the bonding agent is an inorganic material, the bonding agent may include glass, ceramic, etc., and when the bonding agent is an organic material, the bonding agent may include a polymer such as epoxy, etc., but the present invention is not limited thereto. Meanwhile, a thickness of the bonding layer 140 may range from 2 μm to 100 μm.

Meanwhile, when the plurality of ceramic sheets 110 are bonded to each other through the bonding layer 140, the bonding layer 140 may be sintered at a temperature lower than the sintering temperatures of the via electrode 120 and the pattern electrode 130.

Meanwhile, portions other than a portion where the microfluidic channel C is to be formed in the channel forming operation S160, which will be described below, may be coated with the above-described bonding agent, and the entire surface of the second ceramic sheet 112 may also be coated with the above-described bonding agent.

The channel forming operation S160 is an operation of forming the microfluidic channel C by processing the second ceramic sheet 112. That is, in the present invention, the first ceramic sheet 111 may be the ceramic sheet 110 in which a microfluidic channel is not formed, and the second ceramic sheet 112 may be the ceramic sheet 110 in which the microfluidic channel is formed.

The microfluidic channel C of the present invention is formed in an inner layer of the multilayer ceramic substrate 100 and thus is a component that indirectly cools heat generated from a semiconductor chip and transferred to the multilayer ceramic substrate 100 through a fluid (such as an insulating fluid) and may be formed through a process such as laser irradiation or chemical etching.

In this case, as shown in FIG. 4A, when portions other than the portion where the microfluidic channel C is to be formed in the bonding layer forming operation S150 are coated with the bonding agent, the second ceramic sheet 112 of the corresponding portion is processed so that both an internal space of the bonding layer 140 and the processed portion of the second ceramic sheet 112 form the microfluidic channel C, and as shown in FIG. 4B, when the entire surface of the second ceramic sheet 112 is coated with the bonding agent, the second ceramic sheet 112 is processed together with the bonding agent, and thus both the bonding layer 140 and the processed portion of the second ceramic sheet 112 form the microfluidic channel C.

In addition, the microfluidic channel C formed in the second ceramic sheet 112 may be formed to avoid the via electrode 120, and thus the microfluidic channel C and the via electrode 120 are present together on the second ceramic sheet 112. In addition, the microfluidic channel C may include straight portions and curved portions connecting a pair of straight portions and having a curved shape to allow a smooth fluid flow at a bent portion. Furthermore, a plurality of pillars may be formed in the microfluidic channel C to increase a flow rate of a fluid. However, the shape of the microfluidic channel C is not limited as long as it has a shape for heat dissipation of the multilayer ceramic substrate 100.

In addition, at least one of an inlet and an outlet of the microfluidic channel C may be formed in a width direction of the second ceramic sheet 112 or in a thickness direction thereof.

For example, as shown in FIG. 5, when both the inlet and the outlet of the microfluidic channel C are formed in the width direction of the second ceramic sheet 112 and then the multilayer ceramic substrate 100 is manufactured, the fluid may be introduced into the multilayer ceramic substrate 100 in a horizontal direction, may cool the multilayer ceramic substrate 100, and then may be discharged in a direction that is horizontal with respect to the multilayer ceramic substrate 100.

In addition, as shown in FIG. 6, when the inlet of the microfluidic channel C is formed in the thickness direction of the second ceramic sheet 112 and the outlet is formed in the width direction thereof and thus the multilayer ceramic substrate 100 is manufactured, the fluid may be introduced in a direction perpendicular to the multilayer ceramic substrate 100, may cool the multilayer ceramic substrate 100, and then may be discharged in a direction that is horizontal with respect to the multilayer ceramic substrate 100.

Furthermore, although not shown in the drawing, when the inlet of the microfluidic channel C is formed in the width direction of the second ceramic sheet 112 and the outlet is formed in the thickness direction and then the multilayer ceramic substrate 100 is manufactured, the fluid may be introduced in a direction that is horizontal with respect to the multilayer ceramic substrate 100, may cool the multilayer ceramic substrate 100, and then may be discharged in a direction that is perpendicular to the multilayer ceramic substrate 100, and both the inlet and the outlet of the microfluidic channel C may be formed in a thickness direction of the second ceramic sheet 112.

Alternatively, the inlet and the outlet of the microfluidic channel C may each be formed in different second ceramic sheets 112. That is, in the present invention, after the inlet is formed in one second ceramic sheet 112 and the outlet is formed in another second ceramic sheet 112, the inlet and the outlet are formed in different layers using the plurality of second ceramic sheets 112 including the corresponding second ceramic sheets 112 so that the microfluidic channel C may be formed in three dimensions.

Alternatively, the microfluidic channel C may be formed as a plurality of microfluidic channels C in the second ceramic sheet 112. That is, a plurality of inlets and a plurality of outlets of the microfluidic channel C are formed in the second ceramic sheet 112 so that a plurality of fluid spaces may be formed.

Meanwhile, a height of the microfluidic channel C may range from 30 μm to 300 μm, which is the same as a thickness of the second ceramic sheet 112, and a width of the microfluidic channel C may range from 30 μm to 1000 μm. This is because, when the width of the microfluidic channel C is less than 30 μm, fluid flow is insufficient and there is a problem that a heat dissipation function is ineffective, and when the width of the microfluidic channel C exceeds 1000 μm, it is difficult to form the microfluidic channel C to avoid the plurality of via electrodes 120 due to the wide width of the microfluidic channel C, and the remaining area of the second ceramic sheet 112 is reduced, which degrades durability of a corresponding layer.

The bonding operation S170 is an operation of manufacturing the multilayer ceramic substrate 100 with the microfluidic channel C therein by bonding the plurality of ceramic sheets 110 to each other through the bonding layer 140.

In this case, a point to note in the bonding operation S170 is that an empty space is formed between the microfluidic channel C and the via hole H, and therefore the fluid should be completely blocked from leaking out toward the via hole H due to a pressure of the fluid.

More specifically, in the bonding operation S170, the plurality of ceramic sheets 110 coated with the bonding agent to form the bonding layer 140 are laminated to manufacture a laminate, the laminate is then sintered to melt the bonding layer 140, and then the bonding layer 140 is cooled again to firmly bond the plurality of ceramic sheets 110 so that the multilayer ceramic substrate 100 in which the plurality of ceramic sheets 110 are bonded to each other may be manufactured. In this case, the second ceramic sheet 112 may be disposed adjacent to a layer with the most heat generation.

For example, as shown in FIG. 7, when the microfluidic channel C has a single-layer structure, in the bonding operation S170, the first ceramic sheet 111 may be disposed below the second ceramic sheet 112 in which the microfluidic channel C is formed. In this case, it is of course possible to further increase a height of the microfluidic channel C by bonding the plurality of second ceramic sheets 112 in which the microfluidic channel C is formed. Thereafter, the plurality of first ceramic sheets 111 are laminated on an upper or lower side to manufacture a laminate, the laminate is sintered to melt the bonding layer 140, and then the bonding layer 140 is cooled again to be firmly bonded so that the multilayer ceramic substrate 100 in which the plurality of ceramic sheets 110 are bonded to each other may be manufactured.

In addition, as shown in FIG. 8, when the microfluidic channel C has a multilayer structure (i.e., when the microfluidic channel C is formed in a plurality of layers), in the bonding operation S170, the plurality of second ceramic sheets 112 are laminated to allow the microfluidic channel C to have a multilayer structure, the first ceramic sheet 111 is disposed on top of the second ceramic sheet 112, the plurality of first ceramic sheets 111 are laminated on the upper or lower side to manufacture a laminate, and then the laminate is sintered to melt the bonding layer 140 and the bonding layer 140 is cooled to be firmly bonded so that the multilayer ceramic substrate 100 in which the plurality of ceramic sheets 110 are bonded to each other may be manufactured. Finally, upper and lower surfaces of the multilayer ceramic substrate 100 may be smoothly polished, and an external electrode E may be made of a material such as Au.

Thereafter, a cooling fluid made of non-conductive cooling fluid materials, etc., may circulate through the microfluidic channel C inside the multilayer ceramic substrate 100, thereby indirectly cooling heat generated from the semiconductor chip and transferred to the multilayer ceramic substrate 100.

Accordingly, the via electrodes 120 formed in the ceramic sheets 110 are electrically connected through the pattern electrodes 130 so that the plurality of laminated ceramic sheets 110 may be electrically connected to each other. Finally, an external electrode E formed in the lowermost layer may be electrically connected to the pattern electrode 130 of each layer and an external electrode E formed in the uppermost layer through the via electrode 120 so that the heat generated from the semiconductor chip and transferred to the multilayer ceramic substrate 100 may be effectively cooled through the fluid of the internal microfluidic channel C.

Meanwhile, since the bonding layer 140 is formed after the via electrode 120 and the pattern electrode 130 are formed, the bonding layer 140 is formed at a temperature lower than the sintering temperatures of the via electrode 120 and the pattern electrode 130. That is, in the present invention, the sintering temperature may be set to gradually decrease in the order of the via electrode forming operation S130, the pattern electrode forming operation S140, and the bonding operation S170. Furthermore, the melting point may be set to gradually decrease in the order of the conductive paste used for the via electrode 120, the conductive paste used for the pattern electrode 130, and the bonding agent.

According to the present invention including the above-described operations, the multilayer ceramic substrate 100 is sintered or heat-treated at a temperature that does not affect the ceramic sheet 110 so that defects such as deformation and cracks occurring in the ceramic sheet 110 itself may be prevented.

Meanwhile, after the bonding operation S170, the external electrode E or a pad electrode may be formed on each of the upper surface (i.e., the uppermost ceramic sheet 110) and the lower surface (i.e., the lowermost ceramic sheet 110) of the multilayer ceramic substrate 100.

The multilayer ceramic substrate 100 having a cooling system manufactured through the above-described operations includes the plurality of ceramic sheets 110 on which at least one via electrode 120 is formed, a pattern electrode formed on one surface of the ceramic sheets 110 to electrically connect the plurality of via electrodes 120 to each other, and the bonding layer 140 that bonds the plurality of ceramic sheets 110 to each other, the ceramic sheet 110 includes the first ceramic sheet 111 and the second ceramic sheet 112 in which the microfluidic channel C is formed, and the microfluidic channel C has a single-layer or multi-layer structure.

Hereinafter, with reference to the accompanying drawings, a method S200 of manufacturing a multilayer ceramic substrate having a cooling system according to a second embodiment of the present invention will be described in detail.

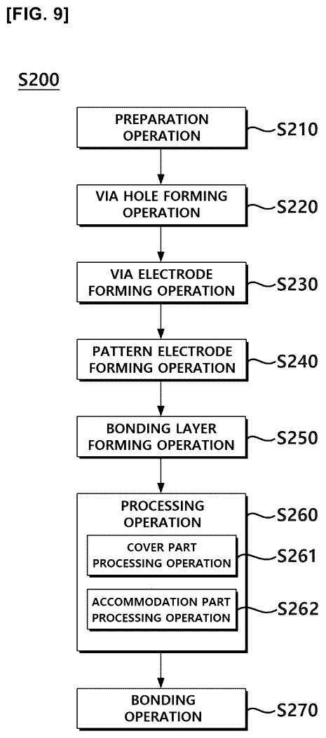

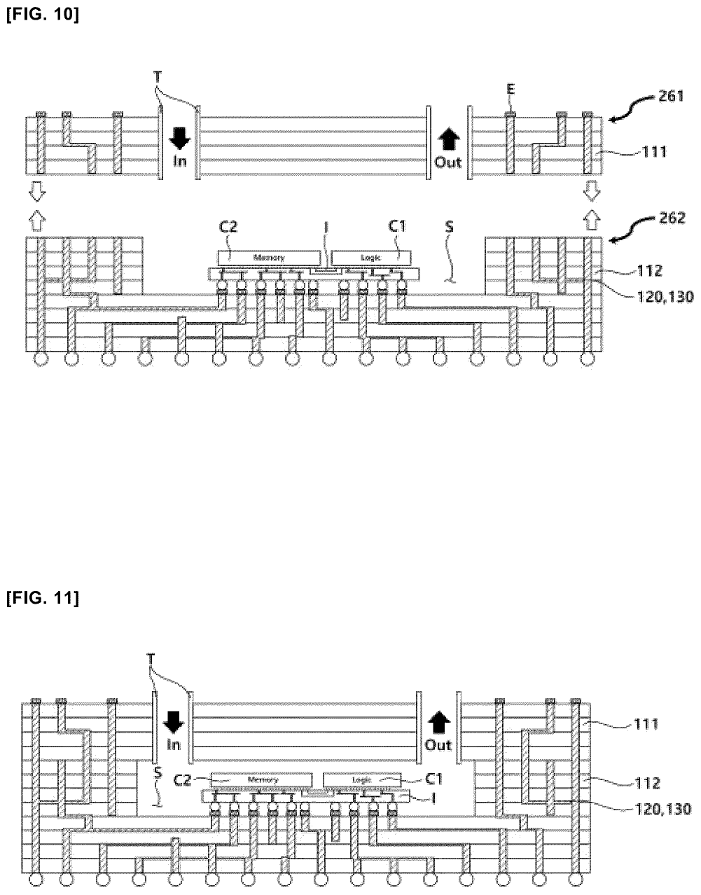

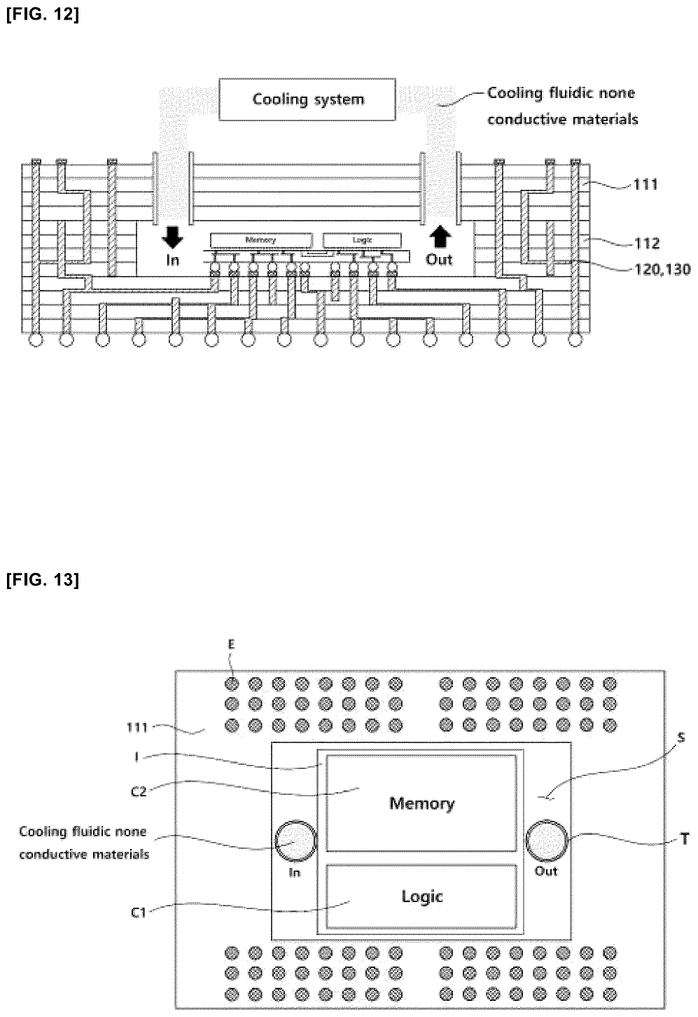

FIG. 9 is a flowchart illustrating a method of manufacturing a multilayer ceramic substrate having a cooling system according to a second embodiment of the present invention, FIG. 10 is a diagram illustrating a cover part and an accommodation part formed through the method of manufacturing a multilayer ceramic substrate having a cooling system according to the second embodiment of the present invention, FIG. 11 is a diagram illustrating the cover part and the accommodation part that are bonded in the method of manufacturing a multilayer ceramic substrate having a cooling system according to the second embodiment of the present invention, FIG. 12 is a diagram illustrating circulation of a fluid in a fluid accommodation space formed through the method of manufacturing a multilayer ceramic substrate having a cooling system according to the second embodiment of the present invention, and FIG. 13 is a plan view illustrating a multilayer ceramic substrate manufactured through the method of manufacturing a multilayer ceramic substrate having a cooling system according to the second embodiment of the present invention.

As shown in FIG. 9, the method S200 of manufacturing a multilayer ceramic substrate having a cooling system according to a second embodiment of the present invention includes a preparation operation S210, a via hole forming operation S220, a via electrode forming operation S230, a pattern electrode forming operation S240, a bonding layer forming operation S250, a processing operation S260, and a bonding operation S270.

Here, the preparation operation S210 to the bonding layer forming operation S250 are the same as the method S100 of manufacturing a multilayer ceramic substrate having a cooling system according to the first embodiment of the present invention, and thus a duplicate description will be omitted.

The processing operation S260 is an operation of processing a plurality of ceramic sheets 110 to form an inlet and an outlet or the fluid accommodation space S through which the fluid is introduced and discharged. More specifically, the processing operation S260 includes a cover part processing operation S261 of bonding and laminating the plurality of first ceramic sheets 111 to each other and forming an inlet into which the fluid is introduced and an outlet through which the fluid is discharged by processing the first ceramic sheets 111, and an accommodation part processing operation S262 of bonding and laminating a plurality of second ceramic sheets 112 to each other and forming the fluid accommodation space S by processing the second ceramic sheets 112.

In this case, the plurality of laminated ceramic sheets 110 may be electrically connected to each other through internal electrodes (including the via electrode 120 and the pattern electrode 130).

As shown in FIG. 10, in the cover part processing operation S261 of the present invention, a cover part 261 may be manufactured such that the inlet into which the fluid is introduced and the outlet through which the fluid is discharged are formed in the plurality of first ceramic sheets 111 and then the plurality of first ceramic sheets 111 are bonded and laminated to each other, or the plurality of first ceramic sheets 111 are bonded and laminated to each other and then the inlet and the outlet are formed in the laminate. In this case, positions of the inlet and the outlet are not particularly limited as long as the positions allow the fluid to circulate easily without interference with the internal electrodes, and the inlet and the outlet may be formed in various internal shapes, such as being formed to pass through in a vertical direction (in a thickness direction of the multilayer ceramic substrate) or pass through in the vertical direction and then extend in a horizontal direction (in a width direction of the multilayer ceramic substrate), but the present invention is not limited thereto. In addition, each of the inlet and the outlet may be formed through a process such as laser irradiation or chemical etching.

That is, the cover part 261 manufactured in the cover part processing operation S261 of the present invention may be the laminate in which the plurality of first ceramic sheets 111 are laminated and may be what the inlet into which the fluid is introduced and the outlet through which the fluid is discharged are formed to pass through.

In this case, a point to note in the cover part processing operation S261 is that an empty space is formed between the inlet/outlet and the via hole H, and therefore the fluid should be completely blocked from leaking out toward the via hole H due to a pressure of the fluid.

In this case, a tube T may be formed on an inner surface of each of the inlet and the outlet formed in the cover part 261 to prevent the fluid from infiltrating into the multilayer ceramic substrate 200 and to allow the fluid to circulate smoothly. The tube T may be formed of a material such as silicone, but the present invention is not limited thereto.

In addition, in the accommodation part processing operation S262 of the present invention, an accommodation part 262 may be manufactured such that the fluid accommodation spaces S are formed by etching some of the plurality of second ceramic sheets 112, and then bonding and laminating a plurality of second ceramic sheets 112 in which the fluid accommodation spaces S are formed and a plurality of second ceramic sheets 112 in which the fluid accommodation spaces S are not formed, or bonding and laminating the plurality of second ceramic sheets 112 to each other and then forming the fluid accommodation spaces S to a preset depth. In addition, the fluid accommodation spaces S may be formed through a process such as laser irradiation or chemical etching.

That is, the accommodation part 262 manufactured in the accommodation part processing operation S262 of the present invention may be a laminate in which the plurality of second ceramic sheets 112 are laminated, and the fluid accommodation space S, which is a space for accommodating an introduced fluid, may be formed in the accommodation part 262.

In this case, a point to note in the accommodation part processing operation S262 is that an empty space is formed between the fluid accommodation space S and the via hole H, and therefore the fluid should be completely blocked from leaking out toward the via hole H due to a pressure of the fluid.

In addition, an interposer I in which a processing chip C1 such as a central processing unit (CPU)/graphics processing unit (GPU)/neural network processing unit (NPU) and/or a memory chip C2 such as a high bandwidth memory (HBM) is installed may be disposed in the fluid accommodation space S formed in the accommodation part 262. That is, the fluid accommodation space S of the present invention may be a space for directly cooling heat generated from a semiconductor chip through a non-conductive cooling fluid. Meanwhile, the interposer I may be formed of a material such as Si and may be a fine-pitch ball grid array (FBGA) using a redistribution layer (RDL) technique, but the present invention is not limited thereto.

Meanwhile, as described in the first embodiment, in the bonding layer forming operation S250, when portions other than portions where the inlet and the outlet are to be formed are coated with the bonding agent, the first ceramic sheet 111 of the corresponding portions is processed and an internal space of the bonding layer 140 and the processed portions of the first ceramic sheet 111 form the inlet and/or the outlet together, and when the entire surface of the first ceramic sheet 111 is coated with the bonding agent, the first ceramic sheet 111 is processed together with the bonding agent, and thus the bonding layer 140 and the processed portions of the first ceramic sheet 111 may form the inlet and the outlet together.

In addition, as described in the first embodiment, in the bonding layer forming operation S250, when portions other than a portion where the fluid accommodation space S is to be formed are coated with the bonding agent, the second ceramic sheet 112 of the corresponding portions is processed so that the internal space of the bonding layer 140 and the processed portions of the second ceramic sheet 112 together form the fluid accommodation space S, and when the entire surface of the second ceramic sheet 112 is coated with the bonding agent, the second ceramic sheet 112 is processed together with the bonding agent so that the bonding layer 140 and the processed portion of the second ceramic sheet 112 may form the fluid accommodation space S together.

Meanwhile, a height of the fluid accommodation space S formed in the second ceramic sheet 112 may range 30 μm to 300 μm, which is the same as the thickness of the second ceramic sheet 112, and a width of the fluid accommodation space S may be appropriately adjusted according to a size of the interposer I to be installed in the fluid accommodation space S.

The bonding operation S270 is an operation of bonding the cover part 261 and the accommodation part 262 to each other, that is, an operation of manufacturing a multilayer ceramic substrate 200 in which the fluid accommodation space S is formed by bonding the laminated first ceramic sheet 111 and the laminated second ceramic sheet 112 to each other.

In this case, a point to note in the bonding operation S2700 is that an empty space is formed between the inlet and the outlet or between the fluid accommodation space S and the via hole H, and therefore the fluid should be completely blocked from leaking out toward the via hole H due to a pressure of the fluid.

More specifically, as shown in FIG. 11, in the bonding operation S270, the multilayer ceramic substrate 200 in which the fluid accommodation space S is formed inside the cover part 261 and the accommodation part 262 by bonding the cover part 261 and the accommodation part 262 such that the cover part 261 and the via electrode and/or the pattern electrode inside the accommodation part 262 are aligned and electrically conducted is manufactured. In this case, the inlet and the outlet formed in the cover part 261 communicate with the fluid accommodation space S formed in the accommodation part 262.

Meanwhile, a method of bonding the cover part 261 and the accommodation part 262 may use glass melting bonding, chemical bonding, and/or mechanical sealing using an O-ring and screw tightening, but the present invention is not limited thereto.

In addition, as described above, the interposer I provided with the processing chip C1 and the memory chip C2 may be installed inside the fluid accommodation space S. In this case, in the bonding operation S270, the interposer I provided with the processing chip C1 and the memory chip C2 is first installed inside the fluid accommodation space S of the accommodation part 262, and then the cover part 261 and the accommodation part 262 are bonded.

Meanwhile, a height of the fluid accommodation space S may be adjusted by adjusting the number of second ceramic sheets 112 forming the fluid accommodation space S in the accommodation part processing operation S262 or by adjusting an etching depth of the laminated second ceramic sheets 112.

Thereafter, the cover part 261 and the accommodation part 262, which are bonded, may be electrically connected to each other through the internal electrodes (including the via electrode 120 and the pattern electrode 130). Finally, upper and lower surfaces of the multilayer ceramic substrate 200 may be smoothly polished, and an external electrode E may be made of a material such as Au.

Thereafter, as shown in FIGS. 12 and 13, after the fluid is injected into the fluid accommodation space S through the tube T of the inlet of the cover part 261, the processing chip C1 and the memory chip C2 are cooled, and then the fluid may be discharged through the tube T of the outlet of the cover part 261. In this case, the fluid accommodated in the fluid accommodation space S may be circulated through an external cooling system provided with a motor, a pump, etc.

Meanwhile, although not shown in the drawing, the interposer I provided with a processing chip C1 may be installed inside the fluid accommodation space S, and a plurality of interposers I provided with the memory chip C2 may be installed on the upper surface of the multilayer ceramic substrate 200 to be electrically connected to the external electrode E.

Accordingly, finally, the external electrode E formed on the lowermost layer may be electrically connected to the external electrode E formed on the uppermost layer through the internal electrodes, i.e., the via electrode 120 and the pattern electrode 130, and heat generated from the processing chip C1 and/or the memory chip C2 of the fluid accommodation space S inside the multilayer ceramic substrate 200 may be effectively cooled through the non-conductive cooling fluid of the fluid accommodation space S.

The multilayer ceramic substrate 200 having a cooling system, which is manufactured through the above-described operations, includes the plurality of ceramic sheets 110 in each of which at least one via electrode 120 is formed, the pattern electrode 130 formed on one surface of the ceramic sheets 110 to electrically connect the plurality of via electrodes 120 to each other, and the bonding layer 140 that bonds the plurality of ceramic sheets 110 to each other, the ceramic sheet 110 includes the first ceramic sheet 111 and the second ceramic sheet 112, and the inlet into which the fluid is introduced and the outlet through which the fluid is discharged are formed in the laminated first ceramic sheet 111, and the fluid accommodation space S is formed in the laminated second ceramic sheet 112.

According to the present invention, since a microfluidic channel for heat dissipation is provided adjacent to a heat source inside a multilayer ceramic substrate, heat inside the multilayer ceramic substrate can be efficiently transferred to the outside of the multilayer ceramic substrate.

In addition, according to the present invention, since an interposer provided with a processing chip and/or a memory chip is installed in a fluid accommodation space formed inside the multilayer ceramic substrate, the corresponding chip can be effectively cooled, and heat generated from the corresponding chip can be prevented from being transferred to the multilayer ceramic substrate.

In addition, according to the present invention, even when a microfluidic channel or the fluid accommodation space is formed inside the multilayer ceramic substrate, a constant thickness of the multilayer ceramic substrate can be maintained without an increase in thickness.

Meanwhile, the effects of the present invention are not limited to the effects mentioned above, and various effects may be included within a range obvious to those skilled in the art from the content which will be described below.

Although all components constituting embodiments of the present invention have been described above as being combined as one or operating in combination, the present invention is not necessarily limited to these embodiments. That is, within the scope of the present invention, one or more of all the components may be selectively combined and operated.

In addition, the terms “include,” “constitute,” and “have” as described above imply that the corresponding component may be present unless otherwise specifically stated, and therefore it should be construed that other components may be further included rather than excluded. Unless otherwise defined, all terms including technical or scientific terms have the same meaning as commonly understood by those skilled in the art to which the present invention pertains. Commonly used terms, such as terms defined in the dictionary, should be construed as consistent with their contextual meaning in the relevant art and will not be interpreted as having an idealistic or excessively formalistic meaning unless clearly defined in the present specification.

In addition, although the embodiments have been described with reference to a number of illustrative embodiments of the technical spirit of the present invention, it should be understood that numerous other modifications and embodiments can be devised by those skilled in the art that will fall within the spirit and scope of the principles of the present invention.

The embodiments disclosed herein, therefore, are not to be taken in a sense of limiting the technical spirit of the present invention but for explanation thereof, and the range of the technical spirit of the present invention is not limited to these embodiments. The scope of the present invention should be construed from the appended claims, along with the full range of equivalents to which such claims are entitled.

What is claimed is:

1. A method of manufacturing a multilayer ceramic substrate having a cooling system, which is formed by sintering a plurality of ceramic green sheets to form a plurality of ceramic sheets and then laminating the plurality of ceramic sheets, the method comprising:
a preparation operation of preparing the plurality of ceramic sheets, wherein the plurality of ceramic sheets include a first ceramic sheet and a second ceramic sheet;
a via hole forming operation of forming a via hole in the ceramic sheets;
a via electrode forming operation of forming a via electrode in the via hole;
a pattern electrode forming operation of forming a pattern electrode on one surface of the ceramic sheets;
a bonding layer forming operation of forming a bonding layer by coating one surface of the ceramic sheets with a bonding agent;
a channel forming operation of forming a microfluidic channel by processing the second ceramic sheet; and
a bonding operation of bonding the plurality of ceramic sheets to each other through the bonding layer.

2. The method of claim 1, wherein the microfluidic channel is formed to avoid the via electrode.

3. The method of claim 2, wherein the microfluidic channel includes straight portions and a curved portion connecting the straight portions.

4. The method of claim 3, wherein an inlet and an outlet of the microfluidic channel are formed in different layers.

5. The method of claim 3, wherein at least one of an inlet and an outlet of the microfluidic channel is formed in a width direction of the second ceramic sheet.

6. The method of claim 3, wherein at least one of an inlet and an outlet of the microfluidic channel is formed in a thickness direction of the second ceramic sheet.

7. The method of claim 3, wherein the microfluidic channel is formed as a plurality of microfluidic channels.

8. The method of claim 3, wherein:
a height of the microfluidic channel ranges from 30 μm to 300 μm; and
a width of the microfluidic channel ranges from 30 μm to 1000 μm.

9. A multilayer ceramic substrate having a cooling system, which is formed by sintering a plurality of ceramic green sheets to form a plurality of ceramic sheets and then laminating the plurality of ceramic sheets, the multilayer ceramic substrate comprising:
the plurality of ceramic sheets in which via electrodes are formed;
a pattern electrode formed on one surface of the ceramic sheets; and
a bonding layer configured to bond the plurality of ceramic sheets to each other,
wherein the ceramic sheets include a first ceramic sheet and a second ceramic sheet, and
a microfluidic channel is formed in the second ceramic sheet.

10. A method of manufacturing a multilayer ceramic substrate having a cooling system, the method comprising:
a preparation operation of preparing a plurality of ceramic sheets formed by sintering ceramic green sheets, wherein the plurality of ceramic sheets include a first ceramic sheet and a second ceramic sheet;
a via hole forming operation of forming a via hole in the ceramic sheets;
a via electrode forming operation of forming a via electrode in the via hole;
a pattern electrode forming operation of forming a pattern electrode on one surface of the ceramic sheets;
a bonding layer forming operation of forming a bonding layer by coating one surface of the ceramic sheets with a bonding agent;
a cover part processing operation of bonding and laminating a plurality of first ceramic sheets to each other, processing the first ceramic sheets, and forming an inlet into which a fluid is introduced and an outlet through which the fluid is discharged;
an accommodation part processing operation of bonding and laminating a plurality of second ceramic sheets to each other, processing the second ceramic sheets, and forming a fluid accommodation space; and
a bonding operation of bonding the laminated first ceramic sheets and the laminated second ceramic sheets to each other.

11. The method of claim 10, wherein:
an interposer is installed in the fluid accommodation space; and
the interposer is provided with a processing chip.

12. The method of claim 11, wherein the interposer is provided with a memory chip.
